(19) United States
(12) Patent Application Publication
(10) Pub. No.: US 2013/0004933 A1
(43) Pub. Date: Jan. 3, 2013

(54) INCREASING CONFIDENCE IN RESPONSES TO ELECTRONIC SURVEYS

(75) Inventor: Vivek Bhaskaran, Seattle, WA (US)

(73) Assignee: SURVEY ANALYTICS LLC, Seattle, WA (US)

(21) Appl. No.: 13/539,180

(22) Filed: Jun. 29, 2012

Related U.S. Application Data
(60) Provisional application No. 61/503,086, filed on Jun. 30, 2011.

(51) Int. Cl. G09B 7/00

(52) U.S. Cl. 434/362

(57) ABSTRACT

A survey confidence system is described that improves the quality of responses through electronic surveys by scoring participant responses using confidence metrics. The system assigns a score to actions taken by the participant that potentially indicate fraud, falsification, or duplication and uses the score to eliminate responses that do not reach a threshold level of confidence, or to weight such responses lower than other higher confidence responses. The system defines a series of axes that the system combines to form an overall confidence score. Each axis represents a particular domain about which the system can determine and assign some level of confidence. The system can inject questions into a survey that verify information that does not change, seldom changes, often changes, or changes according to a recognized pattern. Thus, the system allows the benefits and reduced cost of electronic surveys while increasing confidence in responses to ensure trustworthy results.

### CROSS-REFERENCE TO RELATED APPLICATIONS

The present application claims the benefit of U.S. Provisional Patent Application No. 61/503,086 (Attorney Docket No. SURVEY002) entitled, “INCREASING CONFIDENCE IN RESPONSES TO ELECTRONIC SURVEYS,” and filed on 2011-06-30, which is hereby incorporated by reference.

### BACKGROUND

Surveys have long provided a way for surveyors to gather information. Market researchers often use surveys to determine interest in a particular product, and responses of survey participants to particular design choices may influence the design of a new product. Political pollsters use surveys to determine interest in a candidate and public reaction to particular policy positions. Businesses use surveys internally to determine employee satisfaction. Organizations use surveys to determine what members want from the organization, to plan events, and to gather other information. Surveys often include targeting that selects the group of survey participants based on some criteria, such as membership in an organization, age, gender, political preference, other demographic information, geographic location, past actions, and so forth.

In the past, surveys have often been conducted on paper or by telephone. Paper surveys involve mailing a list of questions to survey participants, and receiving the answers via return mail. One example is the United States Census, which is still a largely paper survey and may include a home visit by a census worker. Paper surveys are expensive, and involve the cost of generating the survey, printing costs, mailing to each participant, tracking responses, and processing returned responses to enter data. Telephone surveys involve paying workers, usually hourly or per call, to call a list of survey participants and ask a list of questions. The worker records the survey responses and may enter the responses in a data entry tool. Telephone surveys are also expensive, and involve the cost of paying the workers, phone service charges, purchase of telephone equipment, and data entry of responses. The cost of paper and telephone surveys often places a limit on the number of participants, which also affects the quality of the survey results. For example, a surveyor may determine that there is only enough budget to phone 1,000 participants for a particular survey.

In recent years, electronic survey systems have become more common, which use websites or other computer applications to electronically transmit a survey to survey participants, and receive responses electronically. Such systems reduce the cost of sending a survey dramatically, and eliminate intermediate steps such as data entry, since the application can directly receive survey data from participants. Many companies have begun offering incentives for completing surveys in order to raise the participation rate among target groups of participants. For example, a survey company may offer points with which to purchase products or services for each survey that a participant completes. Unfortunately, while incentives have substantially increased the participation rate, incentives have also increased fraud whereby a participant completes multiple instances of the same survey, claims to be in a target demographic to which the participant does not belong, and so forth. Paper and telephone surveys provided some inherent protection against such fraud, because the destination address or phone number of the participant, and in the case of telephone surveys the live interaction with the participant avoided some opportunities for falsifying or duplicating responses. Although electronic surveys allow reaching far more participants for the same or lower cost, fraud calls into question the validity of the results and some companies still rely on some level of more traditional surveying to supplement or verify results.

### BRIEF DESCRIPTION OF THE DRAWINGS

FIG. 1 is a block diagram that illustrates components of the survey confidence system, in one embodiment.

FIG. 2 is a flow diagram that illustrates processing of the survey confidence system to receive a survey definition from a survey author, in one embodiment.

FIG. 3 is a flow diagram that illustrates processing of the survey confidence system to receive a survey response from a survey participant, in one embodiment.

### DETAILED DESCRIPTION

A survey confidence system is described herein that improves the quality of responses through electronic surveys by scoring participant responses using one or more confidence metrics. Through various techniques described herein, the system assigns a score to actions taken by the participant that potentially indicate fraud, falsification, or duplication and uses the score to either eliminate responses that do not reach a threshold level of confidence, or to weight such responses lower than other higher confidence responses. In some embodiments, the system defines a series of axes that the system combines to form an overall confidence score. Each axis represents a particular domain about which the system can determine and assign some level of confidence. For example, one axis is the participant's identity. Identity includes information about the participant, such as the participant's gender, age, name, race, area of domicile, income, and so forth.

In some cases, participants sign into the system and the system stores a profile that includes information known or previously provided about the user. The system may also track information such as a participant's Internet Protocol (IP) address, email, mobile device identifier, or other identifying information with which the system can associate previous response data. Upon taking a new survey, the system can inject questions into the survey that verify information that does not change (e.g., gender), seldom changes (e.g., income), often changes (e.g., number of children), changes according to a recognized pattern (e.g., age increases over time), and so forth. If a user gives a response that indicates a change in such data out of character with an expected change, then the system reduces the confidence score. For example, the system may use a confidence score between zero and 100 and initially assign a score of 50 to a particular axis. Based on the participant's responses, the system increases or decreases the score until a final confidence score is reached.

Another axis is speed with which the participant responds to a survey or parts of a survey. The system can track a mean or median speed with which others took the survey or answered particular questions, and can assign a confidence score based on whether the current participant's speed is an outlier or is within the standard deviation of other responses. A participant that blasts through a survey too quickly may indicate someone who is falsifying information simply to earn an incentive, rather than thoughtfully reading and answering the survey questions. Another axis is straight-lining or other patterns in responses, which indicate that the user is always picking the first response, for example, in a multiple-choice survey. The system may randomize an order of responses to determine whether a particular set of choices is simply a common, correct response or whether participants that respond in that way are not providing meaningful and correct information.

The system stores and manages historical information about survey participants, so that participants can establish trust over time based on a history of high confidence responses. The system may provide a profile for users that surveyors can select specifically or in general terms for future surveys. For example, a particular surveyor may want responses only from participants that have been using the system for at least a year, that have taken a threshold number of past surveys, that have a threshold average confidence score, and so forth. The system may also track whether particular information about a participant has been independently verified, such as verifying location based on a driver's license, age or income based on a credit report, and so on. Thus, the survey confidence system allows all of the benefits and reduced cost of electronic surveys while increasing confidence in responses to ensure trustworthy results.

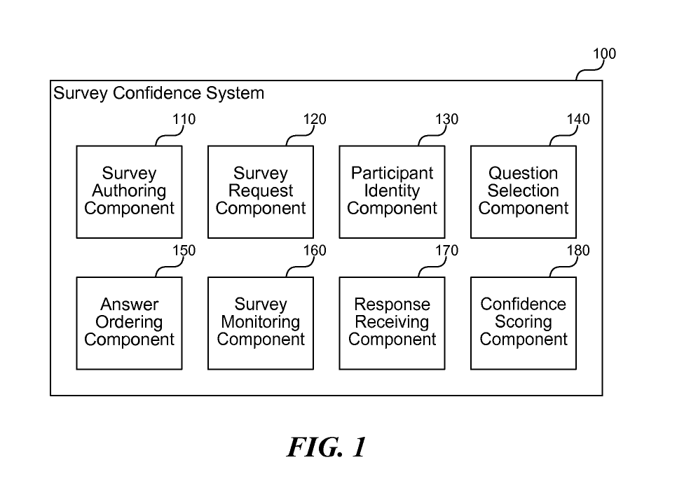

FIG. 1 is a block diagram that illustrates components of the survey confidence system, in one embodiment. The system 100 includes a survey-authoring component 110, a survey request component 120, a participant identity component 130, a question selection component 140, an answer-ordering component 150, a survey-monitoring component 160, a response-receiving component 170, and a confidence-scoring component 180. Each of these components is described in further detail herein.

The survey-authoring component 110 provides a user interface through which survey authors can submit a new survey for distribution to one or more survey participants. The component 110 may provide a web-based interface, a traditional graphical user interface (GUI), a programmatic interface through which other components can submit surveys to the system, and so forth. The authoring component 110 may provide one or more standard controls, question types, or other resources from which survey authors can select to create a survey comprised of one or more questions posed to survey participants. For example, the component 110 may receive multiple-choice questions and associated answers, questions with free-form text-based answers, non-text survey questions such as those that ask the participant to provide an image or other input, and so on. The component 110 may also receive information describing a target audience for the survey, such as demographic criteria of participants, a target number of responses to receive, a threshold confidence score for accepting a survey result, and so forth. For example, a survey author could limit a particular survey to 1,000 males age 25-30 having a confidence score greater than 50.

The system 100 can be implemented as a website or other application and may provide a dedicated uniform resource locator (URL) or other navigation facility through which survey authors activate the authoring component 110 to author surveys. In some embodiments, the system 100 stores a profile for authors similar to that described herein for participants, in which authors are identified as authors and are provided access to the survey authoring component 110. The component 110 may also manage a subscription or other fee-based model through which authors pay to have the system 100 host and distribute their surveys.

The survey request component 120 receives a request from a survey participant to access a survey to which to respond. The component 120 may receive information describing the participant's identity that the component 120 provides to the participant identity component 130 for further processing and gathering information related to the participant. The component 120 may also receive information identifying a specific survey or a class of survey to which the participant is interested in responding. In some embodiments, participants may be open to responding to a variety of surveys in return for one or more incentives offered by survey authors, and the system may select an appropriate survey that matches characteristics of the requesting participant to criteria provided by the survey author(s). Upon identifying a survey to provide to the participant, and identity information of the participant (e.g., data from a cookie or provided as login information by the participant), the system 100 invokes the participant identity component 130 to determine ways to tailor the survey for the particular participant.

The participant identity component 130 identifies survey participants and persistently stores information about participants across multiple sessions with the system 100. The component 130 may also access external sources of participant data to verify information provided by participants. For example, the component 130 may access a Facebook profile associated with a participant to confirm the participant's gender, age, or other data. As another example, the component 130 may access LinkedIn to confirm an employer of the participant, CareerBuilder to purchase additional data about the participant, a credit-reporting agency to determine the participant's FICO score or other credit information, and so on.

The participant identity component 130 includes a data store for storing information received or determined about survey participants. The data store may include one or more files, file systems, hard drives, databases, cloud-based storage services, or other facilities for persistently storing data over time. The data store may include information that the user provided, such as name, age, birthdate, residence information, and so forth, as well as information received from external data sources. The data store may also include historical information related to the participant's interactions with the system 100, such as past surveys taken, average confidence score in past responses, verification information related to profile data provided by the participant, IP address associated with client devices used by the participant, GPS location of the participant during past sessions, and so forth.

The question selection component 140 determines one or more profile-confirming questions to incorporate into the survey identified by the survey request. The system selects one or more profile-confirming questions that serve to confirm or corroborate a participant's previously provided information. For example, the component 140 may select a question asking for the participant's gender or age to confirm previously received gender or age information. During the survey, the system 100 compares the response to previous responses and modifies a confidence score based on any match and/or mismatch. The question selection component 140 selects questions based on configuration information received from an operator of the system 100, indications of important information identified by the survey author (e.g., gender in a gender-based study), and/or random selection of profile-confirming questions.

The answer-ordering component 150 reorders multiple choice answers and survey questions based on confidence-determining criteria. For example, to determine whether some participants are simply choosing the first answer to every question (i.e., straight-lining), the system may randomly reorder multiple choice answers and compare a received pattern of answers to average responses of others. The system 100 can determine how likely a set of answers is received together and then identify outliers upon receipt. The component 150 may also reorder survey questions to embed profile-confirming questions among other questions, to ensure that a user is not biased towards an answer by a previous question, and so on. In some embodiments, the component 150 applies time-based criteria to ensure that questions that are more relevant are answered up front in case survey participants are routinely abandoning a particular survey before reaching the end or for other reasons. A survey author may configure whether and to what extent the system 100 reorders questions.

The survey-monitoring component 160 monitors participant activity during a survey. For example, the component 160 may monitor how long a participant takes to answer each question and/or the survey as a whole. Time can be an indicator of whether the participant read and thought about a question. If the participant rushes through part or all of the survey, then the system may lower the confidence score associated with the participant's answers. The monitoring component 160 may also detect other aspects of the survey environment, such as what type of computing device the participant is using (e.g., smartphone, laptop computer, tablet computer, and so on), what type of input device the participant is using (e.g., touch input, keyboard, mouse), an IP address or other location information (e.g., via GPS, 3G, or Wi-Fi triangulation) associated with the participant, and so forth.

The response-receiving component 170 receives responses from survey participants to the survey questions. The questions can include core survey questions defined by the survey author as well as re-profiling questions that confirm information previously provided by the participant. In some cases, the component 170 receives profile information from a participant for the first time at the outset of or interspersed within other questions of the survey. The response-receiving component 170 may receive responses using any protocol or method known in the art. For example, if the survey is provided as a web page, then the responses may be receive via a Hypertext Transfer Protocol (HTTP) POST message or asynchronously using Asynchronous JavaScript and XML (AJAX) or other technologies. For dedicated local applications, the application may upload responses to a web service, central server, or other location after or while the participant takes the survey. Survey response may include a selection of one of multiple choices in a multiple choice question, text input in a freeform question, or any other type of response called for a by a particular survey question.

The confidence-scoring component 180 determines and updates a confidence score based on information gathered by other components. The component 180 may start with an initial baseline score (which may vary per user based on past user history or be a default value for all users), and modify the score as new information related to trustworthiness or confidence in the participant's answers is received. The component 180 modifies the confidence score based on correct or incorrect responses to re-profiling questions, based on comparison of responses with other environmental information that the component 180 determines, based on speed of answering questions provided by the survey-monitoring component 160, based on detection of potential straight-lining, and so forth. In some cases, a survey author may provide confidence criteria specific to a particular survey that also contribute to the confidence score. At the end or during the survey, the system 100 sends the confidence score with other responses to a central server or other destination for the survey results. The system 100 may discard or weight survey responses lower if the confidence score falls below a particular threshold.

The computing device on which the survey confidence system is implemented may include a central processing unit, memory, input devices (e.g., keyboard and pointing devices), output devices (e.g., display devices), and storage devices (e.g., disk drives or other non-volatile storage media). The memory and storage devices are computer-readable storage media that may be encoded with computer-executable instructions (e.g., software) that implement or enable the system. In addition, the data structures and message structures may be stored or transmitted via a data transmission medium, such as a signal on a communication link. Various communication links may be used, such as the Internet, a local area network, a wide area network, a point-to-point dial-up connection, a cell phone network, and so on.

Embodiments of the system may be implemented in various operating environments that include personal computers, server computers, handheld or laptop devices, multiprocessor systems, microprocessor-based systems, programmable consumer electronics, digital cameras, network PCs, minicomputers, mainframe computers, distributed computing environments that include any of the above systems or devices, set top boxes, systems on a chip (SOCs), and so on. The computer systems may be cell phones, personal digital assistants, smart phones, personal computers, programmable consumer electronics, digital cameras, and so on.

The system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

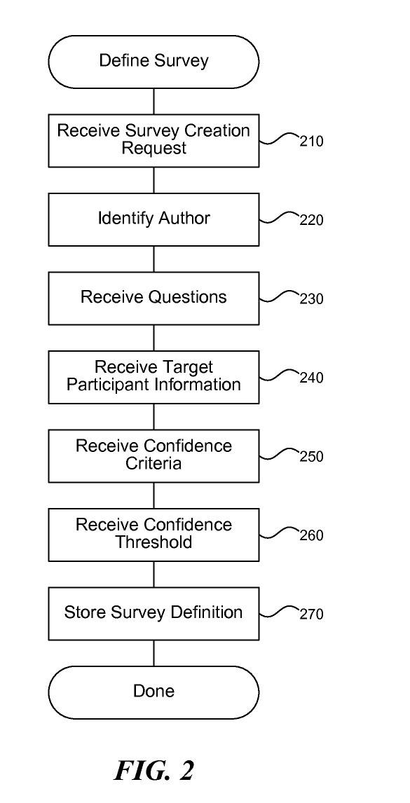

FIG. 2 is a flow diagram that illustrates processing of the survey confidence system to receive a survey definition from a survey author, in one embodiment. Beginning in block 210, the system receives a survey creation request initiated by the survey author. A survey author may initiate a request by visiting a web page for creating surveys hosted by a website associated with the system, by running an application associated with the system (e.g., a smartphone or desktop application), or invoking the system in another way (e.g., programmatically via another program through an application-programming interface (API) provided by the system. Upon receiving the request, the system requests information describing the survey including questions, target participant information, any confidence criteria specific to the survey, a threshold confidence level for which to accept survey responses, and so on.

Continuing in block 220, the system identifies the survey author that initiated the survey creation request. The system may identify the author based on an author profile or information provided by the author (e.g., name, email address, contact information, username/password, and so forth). In some cases, authors have a subscription or other payment plan with an operator of the system and the author profile defines and enforces terms under which the author can use the survey system. For example, the author profile may specify how many surveys the author can create in a period, how many surveys can be active, how long surveys can be, or any other subscription level options defined by the system operator in any particular implementation of the system.

Continuing in block 230, the system receives one or more questions corresponding to the content of a new survey. The system may provide user interface tools and controls for defining common question types (e.g., multiple choice, freeform text, and so on) and may allow authors to define additional question types. For a multiple-choice question, for example, the author provides the question text and the text associated with each answer choice. The author may also indicate whether the system should reorder answers to avoid straight-lining, or whether the answers have a dependent order that should be maintained.

Continuing in block 240, the system receives information describing target participants for taking the new survey. The information may define particular user demographics, a count of users from which to receive responses, any limitations on who can take the survey, rewards and incentives provided for taking the survey, and any other participant information. For example, a survey author can limit a survey to a particular gender, age range, or socioeconomic status and can define how many (or a percentage of) responses an author seeks from each group. For example, a survey author may want an even balance of responses among genders, a distribution of responses to match general population trends, and so on. Surveys can be open to all participants or the system can enforce any received restrictions.

Continuing in block 250, the system receives any confidence criteria specific to the new survey. The system provides a default level of tests to ensure survey responses are valid, but a survey author may have in mind specific additional tests that can determine validity of answers to a specific survey. For example, the author may know that a given answer to one question is incompatible with a given answer to another question, that particular survey participant characteristics are inconsistent with particular answers, and so forth. Thus, the survey author can provide additional criteria that contribute to a more accurate and helpful confidence score for assessing response validity.

Continuing in block 260, the system receives a confidence threshold that identifies a relationship between a confidence score and a valid response. The threshold may include a minimum value, a range, a weighting to apply to responses at certain scores, and so forth. The confidence threshold uses the determined confidence score to separate or minimize the effect of potentially invalid survey responses from the overall results. In some cases, the system may store survey responses with and without confidence thresholding so that the survey author can identify any false negatives and see the effect of the confidence scoring on the results. The system may also receive additional information from the survey author, such as which confidence testing actions to take or avoid (e.g., reordering questions, reordering answers, asking re-profiling questions, and so on). This allows survey authors to tune confidence testing to suit their particular surveys.

Continuing in block 270, the system stores information received in the preceding steps as a survey definition for delivery to one or more survey participants that will respond to the survey. The survey definition includes the received author identification, survey questions, target participant information, confidence criteria, confidence threshold, and any other information associated with the survey. The system stores the survey definition in a data store that may include one or more files, file systems, hard drives, databases, cloud-based storage services, or other facilities for persistently storing survey information. In some embodiments, the system provides a web-based front end that provides a user interface and a backend data store that provides survey information and receives responses. The system may also include one or more client components for efficiently performing confidence testing, may perform testing at a server, or a hybrid approach that combines the two. After block 270, these steps conclude.

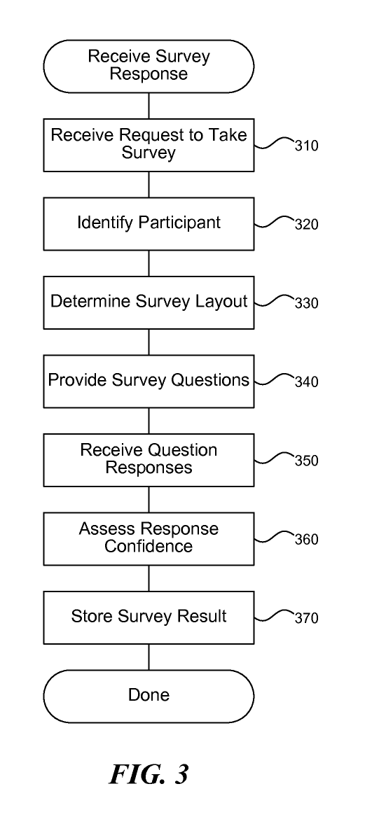

FIG. 3 is a flow diagram that illustrates processing of the survey confidence system to receive a survey response from a survey participant, in one embodiment. Beginning in block 310, the system receives a request to take a survey from a survey participant. The system can deliver surveys in a variety of ways, depending on the goals of a particular operator of the system as well as preferences of users. For example, the system can email surveys, provide a website where participants can take surveys, provide a mobile or other application that is dedicated to a specific survey or that offers a selection of multiple surveys, and so forth. The system receives a request to take a survey when a participant accesses the system to take one or more surveys.

Continuing in block 320, the system identifies the participant from which the request was received. The system may identify participants by tracking mobile device identifiers, storing participant profiles that the participant logs into, receiving participant identifying information (e.g., an email address), and so on. Once the participant is identified, the system accesses any information known about the participant, such as previously collected profile information, information provided with the received request, historical information about the participant, and so on. The system uses information associated with the participant to verify the participant's identity through responses to re-profiling questions and to determine whether the participant matches a target profile for a particular survey.

Continuing in block 330, the system determines a layout of the survey, including ordering of at least one question or answers to a question. The system may reorder questions, interject re-profiling questions among regular survey content, reorder answers to one or more multiple choice questions, and perform other layout steps that are used to determine confidence in answers received from the participant. The system may randomize the layout or shift questions or answers in a predetermined way (e.g., specified by the survey author or determined by the system operator).

Continuing in block 340, the system provides one or more questions associated with the survey to the survey participant in accordance with the determined layout. The system may provide questions through a web page, survey application, email (or other type of) message, or other user interface for displaying survey questions to the participant and receiving survey responses.

Continuing in block 350, the system receives one or more responses to the provided questions. The responses may include an answer chosen among multiple choices, text entered by the participant, or other responsive information. The responses may include some responses to survey questions provided by the survey author and other responses to profiling, re-profiling, or other questions interjected by the system. The responses may also include information about how quickly a response was chosen, whether the responses indicate a consistent choice (e.g., always picking the first or other answer), and so on.

Continuing in block 360, the system assesses a confidence score based on the received responses. The confidence score reflects the system's level of confidence that the survey participant correctly provided information about himself/herself and answered the survey questions thoughtfully and correctly. The system may determine a score per response as well as an overall score for all of the responses to the survey. Questions may be differently weighted so that some questions affect the overall score more than others. Although shown serially for ease of illustration, those of ordinary skill in the art will recognize that the steps can be performed in parallel or optimized in other ways for efficient implementation. For example, the system may receive individual responses and assess a confidence score as the participant responds to each question, or may receive all of the responses in a batch at the end of the survey.

Continuing in block 370, the system stores a survey result that includes the received responses and assessed confidence score. The system may also store specific or anonymous information related to the survey participant, such as demographic information, the participant's identity, or other information. The system stores survey results in a data store that may be the same or different from the data store for storing survey definitions, participant profiles, and author profiles. The system may produce reports for the survey author or others based on stored survey results. For example, a survey author may receive a report from the system indicating how many participants have taken a survey, how many selected each answer, average/median confidence scores, demographic information about participants that have responded, and so forth. After block 370, these steps conclude.

In some embodiments, the survey confidence system is part of a system that provides a variety of surveys. For example, an operator of the system may receive payment from survey authors to host surveys and may pay participants to participate in surveys. The operator can pay participants in a variety of ways, including incentives such as points that can be redeemed for applications from an application store, discounts on products, gift cards, check cards, and so on. The operator may award points for each survey taken to incentivize participants to become routine participants and to return to the operator's web site or application to take more surveys over time. The system may also send notifications to invite reliable survey participants to take new surveys. Being able to ensure that routine participants continue to provide meaningful survey responses over time through the confidence scoring described herein keeps the value of the service to survey authors high.

In some embodiments, the survey confidence system leverages third-party sources of confidence data. For example, the system may access profile information from Facebook, LinkedIn, CareerBuilder, or other sources, may retrieve credit information from credit reporting agencies or a FICO score provider, and may access another confidence provider that can provide additional assurance of a participant's trustworthiness and an additional source of profile information to compare with that provided by the participant to the system.

From the foregoing, it will be appreciated that specific embodiments of the survey confidence system have been described herein for purposes of illustration, but that various modifications may be made without deviating from the spirit and scope of the invention. Accordingly, the invention is not limited except as by the appended claims.

I/We claim:

1. A computer-implemented method to receive a survey response from a survey participant, the method comprising:
receiving a request to take a survey from a survey participant;
identifying the participant from which the request was received;
determining a layout of the survey, including ordering of at least one question or answers to a question;
providing one or more questions associated with the survey to the survey participant in accordance with the determined layout;
receiving one or more responses to the provided questions;
assessing a confidence score based on the received responses; and
storing a survey result that includes the received responses and assessed confidence score,
wherein the preceding steps are performed by at least one processor.

2. The method of claim 1 wherein receiving the request comprises determining that the participant has accessed an application or website for taking surveys.

3. The method of claim 1 wherein identifying the participant comprises identifying a stored participant profile associated with the participant by received login information, where in the participant profile describes surveys previously taken by the participant.

4. The method of claim 1 wherein identifying the participant comprises comparing information associated with the participant with one or more responses to re-profiling questions to verify the participant's identity.

5. The method of claim 1 wherein identifying the participant comprises comparing information associated with the participant to determine whether the participant matches a target profile for a particular survey.

6. The method of claim 1 wherein determining the layout of the survey comprises at least one of reordering questions, interjecting re-profiling questions among regular survey content, and reordering answers to one or more multiple choice questions to determine confidence in answers received from the participant.

7. The method of claim 1 wherein receiving one or more responses comprises receiving some responses to survey questions provided by a survey author and other responses to re-profiling questions added to the survey to verify the participant's responses.

8. The method of claim 1 wherein receiving one or more responses comprises receiving information indicating how quickly a response was chosen.

9. The method of claim 1 wherein receiving one or more responses comprises determining whether the responses indicate a straight-lining answer pattern that selects the same choice from two or more multiple choice questions.

10. The method of claim 1 wherein assessing the confidence score comprises determining a score that reflects a level of confidence that the survey participant correctly provided information about himself/herself and answered the survey questions thoughtfully and correctly.

11. The method of claim 1 wherein assessing the confidence score comprises decreasing the confidence score when the participant provides a response to a question that is inconsistent with information previously provided by the survey participant.

12. A computer system for increasing confidence in responses to electronic surveys, the system comprising:
a processor and memory configured to execute software instructions embodied within the following components;
a survey-authoring component that provides a user interface through which survey authors can submit a new survey for distribution to one or more survey participants;
a survey request component that receives a request from a survey participant to access a survey to which to respond;
a participant identity component that identifies survey participants and persistently stores information about participants across multiple sessions of taking surveys;
a question selection component that determines one or more profile-confirming questions to incorporate into the survey identified by the survey request;
an answer-ordering component that reorders survey questions and multiple choice answers based on confidence-determining criteria;
a survey-monitoring component that monitors participant activity during a survey;
a response-receiving component that receives responses from survey participants to the survey questions; and
a confidence-scoring component that determines and updates a confidence score based on information gathered by other components.

13. The system of claim 12 wherein the survey-authoring component receives a threshold confidence score for accepting a survey result.

14. The system of claim 12 wherein the participant identity component includes a data store for storing information received or determined about survey participants including at least one of information that the user provided, information received from an external data source, historical information related to the participant's interactions with the system, average confidence score in past responses, verification information related to profile data provided by the participant, IP address associated with client devices used by the participant, and GPS location of the participant during one or more past sessions.

15. The system of claim 12 wherein the question selection component selects one or more profile-confirming questions that serve to confirm a participant's previously-provided information, and compares the participant's response to the selected questions to the previously provided information.

16. The system of claim 12 wherein the confidence-determining criteria determine whether a participant is choosing the same answer to each question (i.e., straight-lining).

17. The system of claim 12 wherein the survey-monitoring component monitors how long a participant takes to answer each question to determine a level of confidence that the participant provided a thoughtful answer to each question.

18. The system of claim 12 wherein the confidence-scoring component starts with an initial baseline score and modifies the score up or down as new information related to confidence in the participant's answers is received.

19. A computer-readable storage medium comprising instructions for controlling a computer system to receive a survey definition from a survey author, wherein the instructions, upon execution, cause a processor to perform actions comprising:
receiving a survey creation request initiated by the survey author;
identifying the survey author that initiated the survey creation request;
receiving one or more questions corresponding to the content of a new survey;
receiving information describing target participants for taking the new survey;
receiving any confidence criteria specific to the new survey;
receiving a confidence threshold that identifies a relationship between a confidence score and a valid response; and
storing information received in the preceding steps as a survey definition for delivery to one or more survey participants that can respond to the survey.

20. The medium of claim 19 wherein the confidence threshold uses the determined confidence score to separate or reduce the effect of potentially invalid survey responses.
